(19) United States
(12) Patent Application Publication
(10) Pub. No.: US 2009/0305934 A1
(43) Pub. Date: Dec. 10, 2009

(54) Polymers and their use for inhibition of scale build-up in automatic dishwashing applications

(76) Inventors: Marianne P. Creamer, Warrington, PA (US); Joseph Manna, Quakertown, PA (US); Jan Edward Shulman, Newtown, PA (US)

Correspondence Address: ROHM AND HAAS COMPANY;PATENT DEPARTMENT, 100 INDEPENDENCE MALL WEST, PHILADELPHIA, PA, 19106-2399, US

(21) Appl. No.: 12/387,909

(22) Filed: May 8, 2009

Related U.S. Application Data
(60) Provisional application No. 61/130,865, filed on Jun. 4, 2008.

(51) Int. Cl. C11D 3/37; C02F 5/08

(52) U.S. Cl. 510/221

(57) ABSTRACT

The present invention provides a method of controlling scale in aqueous dishwashing systems which involves adding at least one high molecular weight terpolymer made from one or more monoethylenically unsaturated C₃ to C₆ monocarboxylic acids, one or more monomers having a sulfonic acid group, and one or more monoethylenically unsaturated monomers polymerizable with (I) and (II). In another embodiment, a high molecular weight copolymer made from one or more monoethylenically unsaturated C₃ to C₆ monocarboxylic acids and one or more monomers having a sulfonic acid group is added to the aqueous dishwashing system. Additionally, the present invention provides a machine dishwashing formulation comprising: a builder, which comprises not more than 2% by weight of one or more phosphate groups, based on the total weight of the dishwashing formulation; and the aforesaid terpolymer or copolymer.

This application claims the benefit of priority under 35 U.S.C. §119(e) of U.S. Provisional Patent Application No. 61/130,865 filed on Jun. 4, 2008.

### FIELD OF THE INVENTION

The present invention relates to the field of machine dishwashing formulations, for example detergent and rinse aid formulations, useful for controlling scale in automatic dishwashing systems, for example systems which are substantially free of phosphates.

### BACKGROUND OF THE INVENTION

A common problem encountered in the automatic dishwashing industry concerns formation and accumulation of solid precipitates, often referred to as “scaling”, on the items being cleaned. Municipally-provided water may contain alkaline earth metal cations such as calcium, magnesium, iron, copper, barium, zinc, etc., and several anions such as bicarbonate, carbonate, sulfate, phosphate, silicate, fluoride, etc. When combinations of these anions and cations are present in concentrations which exceed the solubility of their reaction products, solid precipitates form and collect on the items being washed. For example, when the ionic product of magnesium and silicate exceeds the solubility of magnesium silicate, a solid phase of magnesium silicate will form and accumulate on the surfaces of dishes, pots, flatware, plastic dishware and containers, pans and silverware, resulting in unsightly films or spotting on otherwise clean items. Additionally, silica scale (amorphous and/or crystalline) can form on substrates if the concentration of the species is near or above the solubility limits. The mechanism for scale formation on a substrate or in the wash bath may be due to homogenous and/or heterogeneous nucleation, as is well known in the field of aquatic chemistry. In the case of heterogeneous nucleation, scale formation can occur at concentration well below those seen for homogenous nucleation and precipitation.

Automatic dishwashing detergents are generally recognized as a class of detergent compositions distinct from detergents designed for fabric washing or water treatment. A superior automatic dishwashing detergent results in a spotless and film-free appearance (e.g. no scaling or other deposits) on glassware, ceramic dishware, plastic dishware and containers, silverware, flatware, fine china, cookware, and other commonly washed surfaces after a complete cleaning cycle in an automatic dishwashing machine.

Dishwashing detergents are available in many forms, e.g., solids and/or liquids, such as powders, granules, extrudates, liquids, gel-packs, gels, or any combination of consumer product forms. Dishwashing detergent formulations typically include one or more builders, which primarily function as the chelating, cleaning, and pH buffering agent, and a polymeric dispersant for controlling accumulation of inorganic and/or organic scale. Sodium tripolyphosphate (STPP) is commonly used as a builder because it successfully sequesters positive cations, such as magnesium and calcium, in the aqueous washing solution and prevents the species from depositing in the form of insoluble salts (Ca, Mg, Zn, Fe, etc., salts of carbonate, silicate, etc.) on the items being washed. However, it is now known that the presence of phosphate, for example in the form of STPP, in lakes and rivers serves as a nutrient for algae growth (eutrophication) and this results in a deterioration of water quality. These environmental concerns have led to the removal, or significant reduction, of STPP in detergent formulations and their replacement with other sequestering compounds.

Thus, in modern automatic dishwashing compositions phosphate salts are often replaced by non-phosphate builders, such as the salts of citrate, carbonate, silicate, etc, and other organic based builders. The builder species are conveniently available in granular or powder form, and can simply be dry-added to the compositions. Alternatively, the soluble builder may be added as a liquid or gel form, in the appropriate solvent, to the automatic detergent formulation dependent of the type of consumer product form.

(Meth)acrylic acid and maleic acid based polymers have long been used in water treatment. Co- and ter-polymers of (meth)acrylic acid with 2-acrylamido-2-methyl propane sulfonic acid (AMPS) in particular have been proposed for inhibiting sulfate, carbonate and phosphate scale as well as for other treatments like removing rust. For example, U.S. Pat. Nos. 3,332,904; 3,692,673; 3,709,815; 3,709,816; 3,928,196; 3,806,367; 3,898,037; 6,114,294; and 6,395,185 are directed to using AMPS containing polymers. GB No. 2,082,600 proposes an acrylic acid/AMPS/acrylamide polymer and International Patent Application Publication No. WO 83/02607 and International Patent Application Publication No. WO 83/02608 are directed to (meth)acrylic acid/AMPS copolymers as inhibitors of these scales.

U.S. Pat. No. 4,711,725 disclosed the use of (low molecular weight) terpolymers of (meth)acrylic acid/AMPS/substituted acrylamides for inhibiting the precipitation of calcium phosphate.

U.S. Pat. No. 5,023,001 disclosed the use of low molecular weight terpolymers (Mw=10,000) against calcium phosphonate scale.

U.S. Pat. No. 5,277,823 taught the use of (low molecular weight) polymers of (meth)acrylic acid/AMPS/substituted acrylamides, along with additional components, for inhibiting the precipitation of silica or silicate scale.

The inhibition of silica and silicate scaling specifically has also been addressed in several publications. U.S. Pat. No. 4,029,577 is directed to the use of acrylic acid/hydroxylated lower alkyl acrylate copolymers to control a spectrum of scale imparting precipitates including magnesium and calcium silicates. U.S. Pat. No. 4,499,002 discloses (meth)acrylic/(meth)acrylamide/alkoxylated primary alcohol ester of (meth)acrylic acid for the same purpose. Japanese Patent Disclosures 61-107997 and 61-107998 are directed to polyacrylamide and selected (meth)acrylic acid copolymers to control silica scale.

The term copolymer is widely employed in publications, but not always with the same meaning, sometimes referring to a polymer from only two monomers and other times to a polymer from two or more. To avoid ambiguity, the term copolymer as used herein is defined as a polymer being derived from only two monomer types (I) and (II) as defined in the claims, and a terpolymer is a polymer derived from three or more monomer types (I), (II) and (III) as defined in the claims.

The increasing use of dishwashing detergent formulations which are substantially or completely free of phosphate (i.e., “low-P formulations”) has led to an interest in discovering which polymer dispersants perform best in aqueous dishwashing systems treated with such low-P formulations, since these systems do not behave exactly as the previously common phosphate-containing formulations.

### SUMMARY OF THE INVENTION

The present invention provides a method of controlling scale in aqueous dishwashing systems comprising: adding to the aqueous system at least one terpolymer which comprises polymerized units of the following monomers:
(I) 50-88% by weight, for example 60-80% by weight, of one or more weak acids selected from the group consisting of monoethylenically unsaturated C₃ to C₆ monocarboxylic acids, and water soluble salts thereof;
(II) 10-48% by weight, for example 12-30% by weight, of one or more unsaturated sulfonic acids of the formula:

R⁵(R⁶)C═C(R⁷)—X—SO₃Z
wherein Z may be one or more of hydrogen, sodium, potassium, ammonium, a divalent cation or combinations thereof; R⁵ to R⁷, independently of one another, represent —H, —CH₃, a linear or branched, saturated alkyl group containing 2 to 12 carbon atoms, a linear or branched, mono- or polyunsaturated alkenyl group containing 2 to 12 carbon atoms, —NH₂—, —OH— or —COOH-substituted alkyl or alkenyl groups as defined above, or —COOH or —COOR⁴, where R⁴ is a saturated or unsaturated, linear or branched hydrocarbon radical containing 1 to 12 carbon atoms, and X is an optionally present spacer group selected from —(CH₂)ₙ— with n=0 to 4, —COO—(CH₂)ₖ— with k=1 to 6, —C(O)NH—C(CH₃)₂—, —C(O)NH—CH(CH₂CH₃)—, —C(O)NH—C(CH₃)₂CH₂, —C(O)NH—CH₂CH(OH)CH₂, —CH₂—O—C₆H₄, —C₆H₄, —CH₂OCH₂CH(OH)CH₂, —C(O)NH—CH₂CH₂CH₂, —C(O)NH and —C(O)NH—CH₂, or water soluble salts thereof, or is of the formula

HO₃S—X—(R⁸)C═C(R⁹)—X—SO₃Z
in which R⁸ and R⁹, independently of one another, are selected from —H, —CH₃, —CH₂CH₃, —CH₂CH₂CH₃, —CH(CH₃)₂, and X and Z are as hereinbefore defined, or water soluble salts thereof; and
(III) 2-35% by weight, for example 8-20% by weight, of one or more monoethylenically unsaturated monomers polymerizable with (I) and (II),

wherein the total of monomers (I), (II) and (III) equals 100% by weight of terpolymer.

The scale being controlled by the method of the present invention is selected from the group consisting of: silica, calcium silicate, magnesium silicate, zinc silicate, iron silicate, and the calcium, magnesium, zinc, and iron salts of phosphonates, aminocarboxylates, and hydroxycarboxylates, and combinations thereof.

The terpolymer has a weight average molecular weight of from 20,000 to 225,000, for example 20,000 to 150,000, 20,000 to 125,000, 30,000 to 150,000, 30,000 to 125,000, 20,000 to 75,000, 25,000 to 60,000, 30,000 to 60,000, or 30,000 to 50,000.

The terpolymer may be added to a machine dishwashing formulation, for example to a machine dishwashing formulation having not more than 2% by weight of one or more phosphate groups, based on the total weight of the formulation. The one or more phosphate groups may be derived from compounds selected from the group consisting of: sodium tripolyphosphate and tetra potassium pyrophosphate.

The terpolymer may be added to a machine dishwashing detergent formulation used in the aqueous system and the aqueous system is a wash bath of a dishwashing machine.

The terpolymer may also be used in a machine dishwashing rinse aid formulation.

The monoethylenically unsaturated C₃ to C₆ monocarboxylic acid is, for example, selected from the group consisting of one or more of acrylic acid and methacrylic acid.

The unsaturated sulfonic acid is, for example, selected from the group consisting of one or more of 2-acrylamido-2-methyl-1-propanesulfonic acid, 2-methacrylamido-2-methyl-1-propane-sulfonic acid, and water soluble salts thereof.

An example of a terpolymer for use according to the invention is a terpolymer of 70% by weight acrylic acid, 15% by weight of the sodium salt of 2-acrylamido-2-methyl-1-propanesulfonic acid, and 15% by weight ethyl acrylate or tertbutylacrylamide. Such a terpolymer may, for example, have a weight average molecular weight of 30,000 to 50,000.

In another embodiment, a method of controlling scale in aqueous dishwashing systems is provided which comprises adding to the aqueous system at least one copolymer comprising polymerized units of the following monomers:
(I) 50-98% by weight, for example 60-80% by weight, of one or more weak acids selected from the group consisting of monoethylenically unsaturated C₃ to C₆ monocarboxylic acids, and water soluble salts thereof; and
(II) 2-50% by weight, for example 20-40% by weight, of one or more unsaturated sulfonic acids of the formula:

R⁵(R⁶)C═C(R⁷)—X—SO₃Z
wherein Z may be one or more of hydrogen, sodium, potassium, ammonium, a divalent cation or combinations thereof; R⁵ to R⁷, independently of one another, represent —H, —CH₃, a linear or branched, saturated alkyl group containing 2 to 12 carbon atoms, a linear or branched, mono- or polyunsaturated alkenyl group containing 2 to 12 carbon atoms, —NH₂—, —OH— or —COOH-substituted alkyl or alkenyl groups, as defined above, or —COOH or —COOR⁴, where R⁴ is a saturated or unsaturated, linear or branched hydrocarbon radical containing 1 to 12 carbon atoms, and X is an optionally present spacer group selected from —(CH₂)ₙ— with n=0 to 4, —COO—(CH₂)ₖ— with k=1 to 6, —C(O)NH—C(CH₃)₂—, —C(O)NH—CH(CH₂CH₃)—, —C(O)NH—C(CH₃)₂CH₂, —C(O)NH—CH₂CH(OH)CH₂, —CH₂—O—C₆H₄, —C₆H₄, —CH₂OCH₂CH(OH)CH₂, —C(O)NH—CH₂CH₂CH₂, —C(O)NH and —C(O)NH—CH₂, or water soluble salts thereof, or is of the formula

HO₃S—X—(R⁸)C═C(R⁹)—X—SO₃Z
in which R⁸ and R⁹, independently of one another, are selected from —H, —CH₃, —CH₂CH₃, —CH₂CH₂CH₃, —CH(CH₃)₂, and X and Z are as hereinbefore defined, or water soluble salts thereof,

wherein the total of monomers (I) and (II) equals 100% by weight of copolymer.

The scale being controlled is selected from the group consisting of: silica, calcium silicate, magnesium silicate, zinc silicate, iron silicate, and the calcium, magnesium, zinc, and iron salts of phosphonates, aminocarboxylates, and hydroxycarboxylates, and combinations thereof.

The copolymer has a weight average molecular weight of from 30,000 to 225,000, for example 30,000 to 150,000, 30,000 to 125,000, 35,000 to 150,000, 35,000 to 125,000, 35,000 to 75,000 or 40,000 to 60,000.

The copolymer may be added to a machine dishwashing formulation, for example to a machine dishwashing formulation having not more than 2% by weight of one or more phosphate groups, based on the total weight of the formulation. The one or more phosphate groups may be derived from compounds selected from the group consisting of: sodium tripolyphosphate and tetra potassium pyrophosphate.

The copolymer may be added to a machine dishwashing detergent formulation used in the aqueous system and the aqueous system is a wash bath of a dishwashing machine.

The copolymer may also be used in a machine dishwashing rinse aid formulation.

The monoethylenically unsaturated C₃ to C₆ monocarboxylic acid may be selected from the group consisting of one or more of acrylic acid and methacrylic acid.

The unsaturated sulfonic acid is, for example, selected from the group consisting of one or more of 2-acrylamido-2-methyl-1-propanesulfonic acid, 2-methacrylamido-2-methyl-1-propane-sulfonic acid, and water soluble salts thereof.

An example of a copolymer for use according to the invention is a copolymer of 70% by weight acrylic acid and 30% by weight of the sodium salt of 2-acrylamido-2-methyl-1-propanesulfonic acid. Such a copolymer may, for example, have a weight average molecular weight of from 40,000 to 60,000.

The present invention also provides a machine dishwashing formulation comprising: a) 1 to 99.9% by weight of at least one builder, which comprises not more than 2% by weight of one or more phosphate groups, based on the total weight of the dishwashing formulation; and b) 0.1 to 70% by weight of (b1) at least one above-described terpolymer, or (b2) at least one above-described copolymer, or (b3) a combination of (b1) and (b2). The one or more phosphate groups may be derived from compounds selected from the group consisting of: sodium tripolyphosphate and tetra potassium pyrophosphate.

The present invention also provides a machine dishwashing rinse aid formulation comprising (b1) at least one above-described terpolymer, or (b2) at least one above-described copolymer, or (b3) a combination of (b1) and (b2).

In this specification, where reference is made to one embodiment, the feature of that embodiment is considered to be applicable to all embodiments, unless specifically disclosed otherwise.

### DETAILED DESCRIPTION OF THE INVENTION

The method and machine dishwashing formulations of the present invention are each suitable for application in aqueous dishwashing systems to minimize scale build-up on washed items in systems substantially or completely free of phosphates. Particularly, the method and machine dishwashing formulations are suitable for controlling one or more types of scale selected from the group consisting of: silica and divalent/polyvalent salts of silicate, phosphonates, aminocarboxylates, and hydroxycarboxylates. The method and machine dishwashing formulations of the present invention are also useful for inhibiting the formation of inorganic silica scale (amorphous or crystalline) on substrates, as well as for controlling one or more types of organic scale derived from the use of organic carboxylates in the presence of divalent and polyvalent cations.

For example, the one or more types of scale being controlled may be one or more scale selected from the group consisting of: silica scale, calcium silicate, magnesium silicate, zinc silicate andiron silicate scale. Alternatively, for example, the one or more types of scale being controlled may be one or more scale selected from the group consisting of the calcium, magnesium, zinc, and iron salts of phosphonates.

The organic carboxylates which result in organic scale when used in aqueous dishwashing systems include, for example, aminocarboxylates, hydroxy carboxylates, organophosphonates, and the salts of these species.

The aminocarboxylates may include, for example, without limitation, ethylene diamine tetra-acetic acid (EDTA), nitrilo-tri-acetic acid (NTA), diethyl triamine penta-acetic acid (DTPA), 1,3-propylene diamine penta-acetic acid (PDTA), methyl glycine diacetic acid (MGDA), β-alanine diacetic acid (β-ADA), and glutamic acid, N,N-diacetic acid (GLDA).

Examples of the hydroxycarboxylates that may be used include, without limitation, N-(2-hydroxyethyl)imino diacetic acid (HEIDA), N,N-bis(2-hydroxyethyl)glycine (DHEG), hydroxy ethyl-ethylene diamine tri-acetic acid (HEDTA), and N,N,N′,N′-tetrakis-2-hydroxyisopropylethylendiamine (quadrol).

Organophosphonates which typically result in the aforesaid organic scale include, without limitation, diethylene triaminopenta (methylene phosphonic acid) (DTPMP), ethylene diaminotetra(methylene phosphonic acid) (EDTMP), hexamethylene diaminotetra (methylene phosphonic acid) (HDTMP), aminotrimethylene phosphonic acid (ATMP), 1-hydroxy ethylidene-1,1-diphosphonic acid (HEDP), and 2-butane phosphate 1,2,4-tricarboxylic acid (PBTC).

Additionally, the polymers employed in the present invention can be used in combination with one of more polymers of different compositions and molecular weights. For example, it is well known that calcium carbonate, calcium bicarbonate, magnesium carbonate, magnesium bicarbonate, and blends of insoluble (bi)carbonate scale can be controlled/prevented by the use of a polymer produced from combinations of the following monomers or monomer salts of: acrylic acid, methacrylic acid, maleic acid, maleic anhydride, esters of acrylic acid or methacrylic acid, substituted amides or methacrylamides, styrene or α-methyl styrene, and other non-ionic monomers.

The term “substantially or completely free of phosphates,” as used herein, means the machine dishwashing formulations comprise not more than 2% by weight of one or more phosphate groups, based on the total weight of the formulation, and may also be described as “low-phosphate” or “low-P”. Such formulations may comprise no phosphate.

It has been surprisingly discovered that the above-described high molecular weight copolymers provide superior scale control in these low phosphate formulations. The high molecular weight copolymers have high weight average molecular weights of between 30,000 and 225,000. Their superior performance is surprising because, although it is known in the art the (M)AA/AMPS-based copolymers provide good scale control in aqueous dishwashing systems, it was previously unknown that, particularly in low-phosphate aqueous dishwashing systems, copolymers of the known composition, but with greater molecular weights, for example, at least 35,000, or even 50,000 or 70,000, provide increasingly better scale inhibition as the molecular weight increases. This is particularly true in systems which tend to develop one or more scale selected from the group consisting of silica and divalent/polyvalent salts of silicate, phosphonates, aminocarboxylates, and hydroxycarboxylates.

Furthermore, it has also been surprisingly discovered that the above-described high molecular weight terpolymers provide superior scale inhibition. The terpolymers have high weight average molecular weights of between 20,000 and 225,000. Since it is known in the art that polymers having increasing proportions of unsaturated sulfonic acids (e.g., AMPS) provide increasingly better scale control, it was surprising that the aforesaid terpolymer provided further improved scale control even though the proportion of unsaturated sulfonic acids is simultaneously decreased.

As will be seen from the examples illustrating the invention, scale-inhibiting properties of the copolymers and terpolymers increase with increasing molecular weight up to as much as 200,000, however, the most commercially practical polymers are believed to have considerably lower, for example below 100,000, even below 75,000. This is because the viscosity of a polymer increases with increasing molecular weight, so in practice the molecular weight of a commercial polymer is chosen to balance performance and ease of handling (i.e., including ease of manufacture and processing).

Generally, monoethylenically unsaturated C₃ to C₆ monocarboxylic acids suitable for inclusion in either of the aforesaid copolymer or terpolymer include, but are not limited, to unsaturated carboxylic acids corresponding to formula (I):

R¹(R²)C═C(R³)COOZ′ (I)

wherein Z′ may be one or more of hydrogen, sodium, potassium, ammonium, a divalent cation, or combinations thereof; R¹ to R³, independently of one another, represent —H,—CH₃, a linear or branched, saturated alkyl group containing 2 to 3 carbon atoms, or an NH₂— or OH— substituted alkyl group as defined above. For example, R¹ to R³, independently of one another, may represent —H or —CH_{3.} Particular examples of unsaturated carboxylic acids corresponding to formula (I) include acrylic acid (R¹═R²═R³═H) and/or methacrylic acid (R¹═R²═H; R³═CH₃).

Unsaturated sulfonic acids especially suitable for inclusion in either of the aforesaid copolymer or terpolymer include, but are not limited, to unsaturated sulfonic acids corresponding to any of the following formulae (IIa), (IIb) and/or (IIc):

H₂C═CH—X—SO₃Z (IIa)

H₂C═C(CH₃)—X—SO₃Z (IIb)

HO₃S—X—(R⁸)C═C(R⁹)—X—SO₃Z (IIc)

in which R⁸ and R⁹, independently of one another, are selected from —H, —CH₃, —CH₂CH₃, —CH₂CH₂CH₃, —CH(CH₃)₂; X is an optionally present spacer group selected from —(CH₂)ₙ— with n=0 to 4, —COO—(CH₂)ₖ— with k=1 to 6, —C(O)NH—C(CH₃)₂—, —C(O)NH—CH(CH₂CH₃), —C(O)NH—C(CH₃)₂CH₂, —C(O)NH—CH₂CH(OH)CH₂, —CH₂—O—C₆H₄, —C₆H₄, —CH₂OCH₂CH(OH)CH₂, —C(O)NH—CH₂CH₂CH₂, —C(O)NH, and —C(O)NH—CH₂; and Z may be one or more hydrogen, sodium, potassium, ammonium, a divalent cation or combinations thereof.

Examples of unsaturated sulfonic acids include 1-acrylamido-1-propanesulfonic acid (X═—C(O)NH—CH(CH₂CH₃) in formula (IIa)), 2-acrylamido-2-propanesulfonic acid (X═—C(O)NH—C(CH₃)₂, in formula (IIa)), 2-acrylamido-2-methyl-1-propanesulfonic acid (X═—C(O)NH—C(CH₃)₂CH₂, in formula IIa)), 2-methacrylamido-2-methyl-1-propanesulfonic acid (X═—C(O)NH—C(CH₃)₂CH₂, in formula (IIb)), 3-methacrylamido-2-hydroxypropanesulfonic acid (X═—C(O)NH—CH₂CH(OH)CH₂, in formula (IIb)), allyl sulfonic acid (X═CH₂, in formula (IIa)), methallylsulfonic acid (also known as 2-methyl-2-propene-1-sulfonic acid) (X═CH₂, in formula (IIb)), allyloxybenzenesulfonic acid (X═—CH₂—O—C₆H₄, in formula (IIa)), methallyloxybenzenesulfonic acid (X═—CH₂—O—C₆H₄, in formula (IIb)), 2-hydroxy-3-(2-propenyloxy)-propanesulfonic acid (X═—CH₂OCH₂CH(OH)CH₂, in formula (IIa), styrenesulfonic acid (X═C₆H₄, in formula (IIa)), vinylsulfonic acid (X not present in formula (IIa)), 3-sulfopropylacrylate (X═—C(O)NH—CH₂CH₂CH₂, in formula (IIa)), 3-sulfopropylmethacyrlate (X═—C(O)NH—CH₂CH₂CH₂, in formula (IIb)), sulfomethacrylamide (X═—C(O)NH, in formula (IIb)), sulfomethylmethacrylamide (X═—C(O)NH—CH₂, in formula (IIb)), and water-soluble salts of the foregoing acids.

Particular examples of unsaturated sulfonic acids include 2-acrylamido-2-methyl-1-propanesulfonic acid, 2-methacrylamido-2-methyl-1-propanesulfonic acid, and water soluble salts thereof.

The third component of the terpolymer, i.e., the monoethylenically unsaturated monomer polymerizable with monomers (I) and (II), is, for example, one or more monomer selected from the group consisting of: (C₁-C₄)alkyl esters of (meth)acrylic acid, (C₁-C₄)hydroxalkyl esters of (meth)acrylic acid, acrylamide, alkyl substituted acrylamide, N,N-dialkyl substituted acrylamides, sulphonated alkyl acrylamides, vinylphosphonic acid, vinyl acetate, allyl alcohols, sulphonated allyl alcohols, acrylonitrile, N-vinylpyrrolidone, N-vinylformamide, N-vinylimidazole, N-vinylpyridine, styrene and α-methyl styrene. In particular, one or more monomers comprising ethyl acrylate (EA) and/or tert-butylacrylamide (tBAM) and/or hydroxypropyl(meth)acrylate are especially suitable for inclusion in the above-described terpolymer as the third monomer component (III).

The polymers employed in the present invention may be made by any polymerization method, including, for example, solution polymerization, bulk polymerization, heterogeneous phase polymerization (including, for example, emulsion polymerization, suspension polymerization, dispersion polymerization, and reverse-emulsion polymerization), and combinations thereof. Independently, the polymers employed in the present invention may be made with any type of polymerization reaction, including, for example, free radical polymerization. When solution polymerization is used, the solvent may be an aqueous solvent (i.e., the solvent is 75% or more water, by weight, based on the weight of the solvent) or an organic solvent (i.e., a solvent that is not aqueous). At least one polymer may be made by free radical solution polymerization in solution, for example in an aqueous solvent.

The polymers employed in the present invention may be produced using one or more free-radical polymerization reaction, which may involve the use of one or more initiator. An initiator is a molecule or mixture of molecules that, under certain conditions, produces at least one free radical capable of initiating a free-radical polymerization reaction. Some initiators (“thermal initiators”) produce such radicals by decomposing when exposed to sufficiently high temperature. Some initiators produce such radicals when certain molecules are mixed together to cause a chemical reaction that results in at least one free radical (such as, for example, some combinations known as “redox” initiators, which contain at least one oxidizing agent and at least one reducing agent). Some initiators (“photoinitiators”) produce radicals when exposed to radiation, such as, for example, ultraviolet light or electron beam. Also contemplated are initiators that can be exposed to high temperature simultaneously with the presence of at least one reducing agent, and such initiators may produce free radicals by thermal decomposition, by oxidation-reduction reaction, or by a combination thereof.

Examples of suitable photoinitiators are benzophenone, acetophenone, benzoin ether, benzyl dialkyl ketones and derivatives thereof.

Of the suitable thermal initiators, some have a decomposition temperature of 20° C. or higher; or 50° C. or higher. Independently, some have decomposition temperature of 180° C. or lower; or 90° C. or lower. Examples of suitable thermal initiators are inorganic peroxo compounds, such as peroxodisulfates (ammonium and sodium peroxodisulfate), peroxosulfates, percarbonates and hydrogen peroxide; organic peroxo compounds, such as diacetyl peroxide, di-tert-butyl peroxide, diamyl peroxide, dioctanoyl peroxide, didecanoyl peroxide, dilauroyl peroxide, dibenzoyl peroxide, bis(o-tolyl) peroxide, succinyl peroxide, tert-butyl peracetate, tert-butyl permaleate, tert-butyl perisobutyrate, tert-butyl perpivalate, tert-butyl peroctoate, tert-butyl perneodecanoate, tert-butyl perbenzoate, tert-butyl peroxide, tert-butyl hydroperoxide, cumene hydroperoxide, tert-butyl peroxy-2-ethylhexanoate and diisopropyl peroxydicarbamate; azo compounds, such as 2,2′-azobisisobutyronitrile, 2,2′-azobis(2-methylbutyronitrile), 2,2′-Azobis(2-methylpropionamidine)dihydro-chloride, and azobis(2-amidopropane)dihydrochloride.

Thermal initiators can optionally be used in combination with reducing compounds. Examples of such reducing compounds are phosphorus-containing compounds, such as phosphorus acid, hypophosphites and phosphinates; sulfur-containing compounds, such as sodium hydrogen sulfite, sodium sulfite, sodium metabisulfite, and sodium formaldehyde sulfoxylate; and hydrazine. It is considered that these reducing compounds, in some cases, also function as chain regulators.

One group of suitable initiators is the group of persulfates, including, for example, sodium persulfate. One or more persulfate may be used in the presence of one or more reducing agent, including, for example, metal ions (such as, for example, ferrous ion), sulfur-containing ions (such as, for example, S₂O₃⁽⁼⁾, HSO₃⁽⁻⁾, SO₃⁽⁼⁾, S₂O₅⁽⁼⁾, and mixtures thereof), and mixtures thereof.

When initiator is used, the amount of all initiator used, as a weight percentage based on the total weight of all monomers used, is 0.01% or more; or 0.03% or more; or 0.1% or more; or 0.3% or more. Independently, when initiator is used, the ratio of the weight of all initiator used to the total weight of all monomers used is 5% or less; or 3% or less; or 1% or less.

When initiator is used, it may be added in any fashion, at any time during the process. For example, some or all of the initiator may be added to the reaction vessel at the same time that one or more of the monomers is being added to the reaction vessel. The initiator may be added with a constant rate of addition.

The polymers employed in the present invention may also be prepared using a chain regulator. A chain regulator is a compound that acts to limit the length of a growing polymer chain. Some suitable chain regulators are, for example, sulfur compounds, such as mercaptoethanol, 2-ethylhexyl thioglycolate, thioglycolic acid, and dodecyl mercaptan. Other suitable chain regulators are the reducing compounds mentioned herein above. The chain regulator may include sodium metabisulfite. The amount of chain regulator, as a percentage by weight based on the total weight of all monomers used, may be 0.5% or more; or 1% or more; or 2% or more. Independently, the amount of chain regulator, as a percentage by weight based on the total weight of all monomers used, may be 7% or less; or 5% or less; or 3% or less. Amounts of initiator larger that the amount needed to initiate polymerization can act as chain regulator.

Other suitable chain regulators are, for example, the OH-containing compounds described hereinabove as suitable for use in a mixture with water to form a solvent. The chain regulator may be a component of the solvent and thus the chain regulator may be present in amounts larger than 7% by weight based on the total weight of all monomers used.

Chain regulators may be added to the reaction vessel in any fashion. For example, a chain regulator may be added to the reaction vessel at a constant rate of addition, or may be added to the reaction vessel at a rate of addition that increases or decreases or a combination thereof.

Thus, in one embodiment of present invention, controlling scale in aqueous dishwashing systems comprises adding at least one of the above-described high molecular weight terpolymer or copolymer, or mixture thereof, to the aqueous system in an amount of from 0.10% to 70% by weight, typically 0.10% to 20% by weight, based on the total weight of a low-phosphate dishwashing formulation which is also added to the dishwashing machine. This method will control one or more scales selected from the group consisting of silica and divalent/polyvalent salts of silicate, phosphonates, aminocarboxylates, and hydroxycarboxylates.

For example, a copolymer having a composition of 70% by weight acrylic acid and 30% by weight AMPS, based on the total weight of the copolymer, and a molecular weight of 34,000 provides superior scale control in aqueous dishwashing systems treated with low-P builders, as compared to copolymers of the same composition, but having molecular weights less than about 21,000. A copolymer having a composition of 70% by weight acrylic acid and 30% by weight AMPS, based on the total weight of the copolymer, and a molecular weight of 56,000 provides superior scale control in aqueous dishwashing systems treated with low-P builders, as compared to copolymers of the same composition, but having molecular weights less than about 34,000.

The method of the present invention may further comprise also adding a substantially or completely phosphate free builder to the aqueous system.

The dishwashing detergent formulations of the present invention may contain one or more substantially or completely phosphate free (low-P) builders, as are known in the art. For example, such low-P builders include, for example, without limitation, zeolites, silicates, carbonates, polycarboxylates, and organic cobuilders. The one or more builders are present in an amount of from 1 to 99.9% by weight based on the total weight of the dishwashing formulation. The dishwashing detergent formulation also comprises 0.1 to 70% by weight of at least one of the aforementioned terpolymer, copolymer, or a mixture thereof.

In one example of the formulations in accordance with the present invention, the monomer (I) is acrylic acid, the monomer (II) is AMPS and the monomer (III) (the one or more monoethylenically unsaturated monomers) is, if present, selected from the group consisting of ethyl acrylate (EA), tert-butylacrylamide (tBAM) and hydroxypropyl(meth)acrylate (HPA).

In addition to the builder and dispersant polymer ingredients, the detergent formulations according to the present invention may contain other typical ingredients known in the field such as, without limitation, caustic (i.e., NaOH and/or KOH), bleaching agents (for example, the hypochlorite salts, perborate salts, percarbonate salts), bleach activators, nonionic and/or anionic low foaming surfactants, enzymes, silver protectors, glass protector (zinc and silicate containing materials), suds suppressor, cobuilders, dyes, perfumes, solvents, hydrotropes, detergent binders (for example: polyethylene glycol), waxes, lime-soap dispersants, non-dispersant water soluble polymers (for example: polyvinyl alcohol films), and buffering agents, etc. However, other solid mono-, oligo- and polycarboxylic acids, as builders, in particular may also be used. Examples within this group include tartaric acid, succinic acid, malonic acid, adipic acid, maleic acid, fumaric acid, oxalic acid and polyacrylic acid. Organic sulfonic acids, such as amidosulfonic acid, may also be used.

Another possible group of ingredients is chelating agents. Chelating agents are substances which form cyclic complexes with metal ions, an individual ligand occupying more than one co-ordination site at a central atom, i.e. is at least “bidentate”, In this case, therefore, normally stretched compounds are closed to form rings by complexing via an ion. The number of bound ligands depends upon the co-ordination number of the central ion.

Typical chelating agents include, for example, polyoxycarboxylic acids, polyamines, ethylenediamine tetraacetic acid (EDTA) and nitrilotriacetic acid (NTA). Complexing polymers, i.e. polymers which, either in the main chain itself or laterally thereof, carry functional groups which are capable of acting as ligands and which react with suitable metal atoms, generally to form chelate complexes, may also be used in accordance with the invention. The organic carboxylates discussed hereinabove as builders (i.e., aminocarboxylates, hydroxy carboxylates, organophosphonates) may also serve as chelating agents.

Complexing groups (ligands) of typical complexing polymers are iminodiacetic acid, hydroxyquinoline, thiourea, guanidine, dithiocarbamate, hydroxamic acid, amidoxime, aminophosphonic acid, (cycl.) polyamino, mercapto, 1,3-dicarbonyl and crown ether residues with, in some cases, very specific activities towards ions of various metals.

The formulations described herein may also include one or more suitable surfactants, or optionally a surfactant system, in any suitable amount or form. Suitable surfactants include anionic surfactants, cationic surfactants, nonionic surfactants, amphoteric surfactants, ampholytic surfactants, zwitterionic surfactants, and mixtures thereof. For example, a mixed surfactant system may comprise one or more different types of the above-described surfactants. The composition may be substantially free of surfactants. As used herein “substantially free” means that surfactants should be present at levels less than 0.5 wt % by weight of the composition. Typical surfactants are disclosed in patent application US2007/0015674A1.

As indicated, the dishwashing detergent formulations of the invention can be in any desired product form such as solids, tablets, powders, granulates, pastes, liquids and gels and combinations thereof. With selection of an appropriate product form and addition time of the formulation to the dishwashing machine during the washing sequence, it is possible that the polymers employed in the present invention can be present in the prewash, main wash, penultimate rinse, final rinse, or any combination of these cycles. Additionally, it should be recognized that the polymers employed in the present invention can be employed in an effective amount in the prefinal and/or final rinse cycle of a dishwashing sequence to prevent scaling and/or spotting from the inorganic and/or organic precipitate formed from the aforementioned phosphate-free or low phosphate formulation with the anions, cations, and silica species present.

Additionally, it is contemplated that the polymers employed in the present invention can also be formulated with any number of the following non limiting, conventional, ingredients: surfactants, hydrotropes, water, acid or neutral builders (example, citric acid or sodium citrate), and adjuvants (fragrances, perfumes, colorants) to generate a rinse aid formulation that may be separately added to the penultimate and final rinse of the dishwashing sequence. These rinse aids may have a pH of from 2 to as high as 12.

Water soluble polymer molecular weights reported herein, unless otherwise indicated, are weight average molecular weights, Mw, as measured by gel permeation chromatography (GPC) using well defined polyacrylic acid standards, as is known in the art. Gel permeation chromatography, otherwise known as size exclusion chromatography, actually separates the members of a distribution of polymer chains according to their hydrodynamic size in solution rather than their molar mass. The system is then calibrated with standards of known molecular weight and composition to correlate elution time with molecular weight. The techniques of GPC are discussed in detail in Modern Size Exclusion Chromatography, W. W. Yau, J. J Kirkland, D. D. Bly; Wiley-Interscience, 1979, and in A Guide to Materials Characterization and Chemical Analysis, J. P. Sibilia; VCH, 1988, p. 81-84. The molecular weights reported herein for Mw are in Daltons.

### EXAMPLES

The method and formulation of the present invention will be clarified by the following examples.
Key to acronyms used herein:
AA=acrylic acid
AMPS=2-acrylamido-2-methyl-1-propane sulfonic acid
Na AMPS=2-acrylamido-2-methyl-1-propane sulfonic acid sodium salt
tBAM=tertbutylacrylamide
EA=ethyl acrylate
HPA=hydroxypropyl acrylate
MAA=methacrylic acid.
HEDP=1-hydroxy ethylidene-1,1-diphosphonic acid (Dequest 2016D from Thermphos Trading GmbH).

All compositions for the polymers are reported in weight % of the pre-polymerized monomer components.

ACUSOL is a registered trademark of Rohm and Haas Company.

The following examples are focused on distinct automatic dishwashing bases (i.e., builder and other ingredients of detergent formulation): Base #5 (a high silicate composition) and Base #7, which is a modified version of high carbonate Base #1 with added HEDP (a phosphonate). Although phosphonates are well known as excellent inhibitors of calcium carbonate scale, their use produces calcium phosphonate scale.

A suitable level of polymer for a specific detergent formulation depends on a number of factors; for example, detergent formulation type, nature of the polymer, water hardness, specific scale, temperature of the dishwashing application, as well as a number of other factors. In general, higher amounts of polymer additions are required to control silicate scale compared to phosphonate scale.

### Formulations

| | | | BASE #7 |
|---|---|---|---|
| | BASE #1 | BASE #5 | (with |
| | (HIGH | (HIGH | phosphonate |
| | CARBONATE) | SILICATE) | HEDP) |
| Ingredients | Weight % | Weight % | Weight % |
| Sodium Citrate | 10 | 10 | 10 |
| Sodium Carbonate | 30 | 2.5 | 30 |
| Sodium Bicarbonate | 20 | 2.5 | 20 |
| Disilicate (Britesil H20 | 7 | 25 | 10 |
| from PQ Corp., USA) | | | |
| SKS-6 (Soluble silicate | 3 | 5 | 0 |
| Na₂Si₂O₅) | | | |
| CDB Clearon (sodium | 1 | 1 | 1 |
| dichloroisocyanurate | | | |
| dihydrate) | | | |
| Low Foam Nonionic | 1 | 1 | 1 |
| Surfactant (SLF-18) | | | |
| Phosphonate (HEDP) | 0 | 0 | 1.0 |
| Sodium Sulfate (Filler) | 28 | 53 | 27 |

The polymers added to the formulation for the experiments below were in a dry form and added to the powder formulation.

The following conditions were used for all examples, unless specifically mentioned:

Sears Kenmore dishwashers, Ultra Wash, QuietGuard Deluxe models were used. For Examples 1A, 2 and 3, Sears Kenmore Ultra Wash Model Number 665.15872 was used. This model was run on the “Normal Program”, in which the wash cycle lasted 40 minutes. For all other examples, Sears Kenmore Ultra Wash Model Number 665.13732 was used. This model was run on the “Fast Wash” program, in which the wash cycle lasted 30 minutes. Examples 1A and 1B were run at 130° F. (54° C.). Examples 2 to 13 were run at 135° F. (57° C.).

The glasses & ballast of each of the dishwashers were pre-stripped with citric acid prior to start of experiments. Libbey Collins glasses were used, with no food soil.

Water with 400 ppm hardness (2:1 Ca^{2+:}Mg²⁺) was used. This was achieved starting with tap water in tank then CaCl₂ & MgCl₂ solutions were added to the tank in a 2:1 ratio.

Glassware filing rating was measured, after a number of consecutive cycles had been run, using ASTM Rating System (1-5), “1” meaning “clear glass” and “5” meaning “heavily filmed”.

### Examples 1A and 1B

These example compared the anti-scaling effect of polymers in Base #5 (high silicate) detergent, and at different levels of polymer inclusions.

For each cycle run, 50 g of the specified base formulation were added to each of the pre-wash and the main wash. In addition, 1.0% (0.5 g) polymer solids were added to each of the pre-wash and the main wash in Example 1A and 2% (1.0 g) polymer solids were added to each of the pre-wash and the main wash in Example 1B.

### Example 1A

TABLE IA

| | Polymer | | | |
|---|---|---|---|---|
| | Molecular | Average Filming Scores | | |
| Formulation | Weight | Cycle 1 | Cycle 3 | Cycle 5 |
| Base #5 + 0.5 g Polymer A | 20,940 | 1.5 | 2.4 | 2.9 |
| Base #5 + 0.5 g Polymer B | 35,903 | 1.4 | 2.7 | 3.2 |
| Base #5 + 0.5 g Polymer C | 36,062 | 1.3 | 1.8 | 2.1 |
| Base #5 + 0.5 g Polymer E | 7,400 | 1.4 | 2.3 | 3.5 |

### Example 1B

TABLE 1B

| | Polymer | Average Filming Scores | |
|---|---|---|---|
| | Molecular | Rating after 3 | Rating after 5 |
| Formulation | Weight | Cycles | Cycles |
| Base #5 - no polymer | | 4.7 | 5.0 |
| Base #5 + 1.0 g Polymer A | 20,940 | 1.9 | 3.5 |
| Base #5 + 1.0 g Polymer B | 35,903 | 1.7 | 3.5 |
| Base #5 + 1.0 g Polymer C | 36,062 | 1.6 | 2.2 |
| Base #5 + 1.0 g Polymer E | 7,413 | 4.9 | 5.0 |

Polymer A = Copolymer of 70% AA and 30% NaAMPS (Comparative)
Polymer B = Terpolymer of 70% AA, 15% NaAMPS, and 15% EA
Polymer C = Terpolymer of 70% AA, 15% NaAMPS, and 15% tBAM
Polymer E = Terpolymer of 65% AA, 27% NaAMPS, and 8% tBAM.

### Example 2

This example compared the anti-scaling effect of polymers in Base #7 (phosphonate-containing) detergent.

For each cycle run, 50 g of the specified base formulation and 1.0% (0.5 g) polymer addition were added to each of the pre-wash and the main wash.

TABLE 2

| | Filming Rating after 5 |
|---|---|
| Formulation | Cycles |
| 1) Base #7 + 0.5 g ACUSOL 425N | 3.03 |
| 2) Base #7 and no polymer | 3.63 |
| 3) Base #7 + 0.5 g Polymer A | 1.17 |

ACUSOL 425N is a low molecular weight polycarboxylate that does not contain a sulfonic acid functional group. This low molecular weight (Mw ~2,000) polymer is an excellent calcium carbonate scale inhibitor.
Polymer A = Copolymer of 70% AA and 30% NaAMPS (Comparative)

### Example 3

This example compared the anti-scaling effect of polymers in Base #7 (phosphonate-containing) detergent.

For each cycle run, 40 g of the specified base formulation and 0.5% (0.2 g) polymer solids were added to each of the pre-wash and the main wash.

TABLE 3

| | Filming Rating after 6 |
|---|---|
| Formulation | Cycles |
| 1) Base #7 - no polymer | 2.90 |
| 2) Base #7 + 0.2 g Polymer A | 1.97 |
| 3) Base #7 + 0.2 g Polymer D | 2.97 |

Polymer A = Copolymer of 70% AA and 30% NaAMPS, Mw = 20,940 (Comparative)
Polymer D = Polymer of 100% AA, Mw = 23,699 (Comparative)

This example shows that a polycarboxylate polymer (D) is comparable to an absence of polymer at controlling phosphonate scale. However, a polymer (A) having a similar molecular weight to D but comprising 30% sulfonated monomer (Na AMPS) is effective at controlling phosphonate scale.

### Example 4

This example compared the anti-scaling effect of polymers in Base #7 detergent (phosphonate-containing).

For each cycle run, 50 g of the specified base formulation and 0.4% (0.2 g) polymer solids were added to each of the pre-wash and the main wash.

TABLE 4

| | Filming Rating after 10 |
|---|---|
| Formulation | Cycles |
| 1) Base #7 - no polymer | 3.90 |
| 2) Base #7 + 0.2 g Polymer A | 2.53 |
| 3) Base #7 + 0.2 g Polymer B | 1.60 |
| 4) Base #7 + 0.2 g Polymer F | 1.40 |

Polymer A = Copolymer of 70% AA and 30% NaAMPS, Mw = 20,940 (Comparative)
Polymer B = Terpolymer of 70% AA, 15% NaAMPS, and 15% EA, Mw = 35,903
Polymer F = Terpolymer of 70% AA, 15% NaAMPS, and 15% tBAM, Mw = 32,544

### Example 5

This example compared the anti-scaling effect of polymers in Base #7 detergent (phosphonate-containing).

For each cycle run, 50 g of the specified base formulation and 0.4% (0.2 g) polymer solids were added to each of the pre-wash and the main wash.

TABLE 5

| | Filming Rating after 9 |
|---|---|
| Formulation | Cycles |
| 1) Base #7 - no polymer | 3.20 |
| 2) Base #7 + 0.2 g Polymer A | 2.40 |
| 3) Base #7 + 0.2 g Polymer G | 1.77 |
| 4) Base #7 + 0.2 g Polymer H | 1.90 |

Polymer A = Copolymer of 70% AA and 30% NaAMPS, Mw = 20,940 (Comparative)
Polymer G = Copolymer of 70% AA and 30% NaAMPS, Mw = 33,925
Polymer H = Terpolymer of 70% AA, 15% NaAMPS, and 15% HPA, Mw = 39,684.

### Example 6

This example compared the anti-scaling effect of polymers in Base #5 (high silicate) detergent.

For each cycle run, 50 g of the specified base formulation and 2.0% (1.0 g) polymer solids were added to each of the pre-wash and the main wash.

TABLE 6

| | Filming Rating after 5 |
|---|---|
| Formulation | Cycles |
| 1) Base #5 + 1.0 g Polymer A | 4.03 |
| 2) Base #5 + 1.0 g Polymer F | 2.97 |
| 3) Base #5 + 1.0 g Polymer D | 3.73 |
| 4) Base #5 + 1.0 g Polymer J | 4.00 |

Polymer A = Copolymer of 70% AA and 30% NaAMPS, Mw = 20,940 (Comparative)
Polymer F = Terpolymer of 70% AA, 15% NaAMPS, and 15% tBAM, Mw = 32,544
Polymer D = Polymer of 100% AA, Mw = 23,699 (Comparative)
Polymer J = Copolymer of 85% AA and 15% tBAM, Mw = 48,640 (Comparative)

### Example 7

This example compared the anti-scaling effect of polymers in Base #7 (phosphonate-containing) detergent.

For each cycle run, 50 g of the specified base formulation and 0.4% (0.2 g) polymer solids were added to each of the pre-wash and the main wash.

TABLE 7

| | Filming Rating after 9 |
|---|---|
| Formulation | Cycles |
| 1) Base #7 + 0.2 g Polymer A | 1.90 |
| 2) Base #7 + 0.2 g Polymer K | 1.43 |
| 3) Base #7 + 0.2 g Polymer G | 1.43 |

Polymer A = Copolymer of 70% AA and 30% NaAMPS, Mw = 20,940 (Comparative)
Polymer G = Copolymer of 70% AA and 30% NaAMPS, Mw = 33,925
Polymer K = Terpolymer of 70% AA, 15% % NaAMPS, and 15% EA, Mw = 32,000

### Example 8

This example compared the anti-scaling effect of polymers in Base #5 (high silicate) detergent.

For each cycle run, 50 g of the specified base formulation and 1% (0.5 g) polymer solids were added to each of the pre-wash and the main wash.

TABLE 8

| | Filming Rating after 5 |
|---|---|
| Formulation | Cycles |
| 1) Base #5 + 0.5 g Polymer A | 4.37 |
| 2) Base #5 + 0.5 g Polymer G | 4.17 |

Polymer A = Copolymer of 70% AA and 30% NaAMPS, Mw = 20,940 (Comparative)
Polymer G = Copolymer of 70% AA and 30% NaAMPS, Mw = 33,925

### Example 9

This example compared the anti-scaling effect of polymers in Base #7 (phosphonate-containing) detergent.

For each cycle run, 50 g of the specified base formulation and 0.3% (0.15 g) polymer solids were added to each of the pre-wash and the main wash.

TABLE 9

| | Filming Rating after 9 |
|---|---|
| Formulation | Cycles |
| 1) Base #7 + 0.15 g Polymer A | 3.30 |
| 2) Base #7 + 0.15 g Polymer G | 3.00 |
| 3) Base #7 + 0.15 g Polymer L | 2.60 |

Polymer A = Copolymer of 70% AA and 30% NaAMPS, Mw = 20,940 (Comparative)
Polymer G = Copolymer of 70% AA and 30% NaAMPS, Mw = 33,925
Polymer L = Copolymer of 70% AA and 30% NaAMPS, Mw = 58,760

### Example 10

This example compared the anti-scaling effect of polymers in Base #5 (high silicate) detergent.

For each cycle run, 50 g of the specified base formulation and 1.0% (0.5 g) polymer solids were added to each of the pre-wash and the main wash.

TABLE 10

| | Filming Rating after 3 |
|---|---|
| Formulation | Cycles |
| 1) Base #5 + 0.5 g Polymer A | 4.43 |
| 2) Base #5 + 0.5 g Polymer K | 4.00 |
| 3) Base #5 + 0.5 g Polymer L | 3.63 |

Polymer A = Copolymer of 70% AA and 30% NaAMPS, Mw = 20,940 (Comparative)
Polymer K = Terpolymer of 70% AA, 15% NaAMPS, and 15% EA, Mw = 32,000
Polymer L = Copolymer of 70% AA and 30% NaAMPS, Mw = 58,760

### Example 11

### Comparison of Scaling Effects of Polymers Against Different Scales

Example 11 compared the anti-scaling effect of polymers in (A) Base #5 (high silicate) and (B) Base #1 (high carbonate).

### Example 11A

Example showing the results of the above polymers in a high silicate formulation (Base #5).

Example 11A was carried out at water hardness of 400 ppm (2:1 Ca²⁺:Mg²⁺)

For each cycle run, 40 g of the specified base formulation and 1.875% (0.75 g) polymer solids were added to each of the pre-wash and the main wash.

TABLE 11A

| | | | Filming Rating |
|---|---|---|---|
| Formulation | Polymer Level | Polymer | after 2 Cycles |
| 1) Base #5 | None | None | 3.65 |
| 2) Base #5 | 0.75 grams | Polymer A | 3.25 |
| 3) Base #5 | 0.75 grams | Polymer B | 3.00 |
| 4) Base #5 | 0.75 grams | Polymer C | 2.90 |
| 5) Base #5 | 0.75 grams | Polymer E | 3.55 |

Polymer A = Copolymer of 70% AA and 30% NaAMPS, Mw = 20,940 (Comparative)
Polymer B = Terpolymer of 70% AA, 15% NaAMPS, and 15% EA, Mw = 35,903
Polymer C = Terpolymer of 70% AA, 15% NaAMPS, and 15% tBAM, Mw = 36,062
Polymer E = Terpolymer of 65% AA, 27% NaAMPS, and 8% tBAM, Mw = approx 7,400 (Comparative)

This comparison shows that Polymers B and C are better than E and A (comparative) at controlling high silicate scale.

### Example 11B

Example showing the results of the above polymers in a high carbonate formulation (Base #1).

Example 11B was carried out at water hardness of 375 ppm (2:1 Ca²⁺:Mg²⁺).

For each cycle run, 40 g of the specified base formulation and 1.875% (0.75 g) polymer solids were added to each of the pre-wash and the main wash.

TABLE 11B

| | | | Filming Rating |
|---|---|---|---|
| Formulation | Polymer Level | Polymer | after 2 Cycles |
| 1) Base #1 | None | None | 4.74 |
| 2) Base #1 | 0.75 grams | Acusol 425N | 2.0 |
| 2) Base #1 | 0.75 grams | Polymer A | 5 |
| 3) Base #1 | 0.75 grams | Polymer B | 5 |
| 4) Base #1 | 0.75 grams | Polymer C | 5 |
| 5) Base #1 | 0.75 grams | Polymer E | 5 |

ACUSOL 425N is a low molecular weight polycarboxylate that does not contain a sulfonic acid functional group. This low molecular weight (Mw ~2,000) polymer is an excellent calcium carbonate scale inhibitor.
Polymer A = Copolymer of 70% AA and 30% NaAMPS, Mw = 20,940 (Comparative)
Polymer B = Terpolymer of 70% AA, 15% NaAMPS, and 15% EA, Mw = 35,903
Polymer C = Terpolymer of 70% AA, 15% NaAMPS, and 15% tBAM, Mw = 36,062
Polymer E = Terpolymer of 65% AA, 27% NaAMPS, and 8% tBAM, Mw = 7,400 (Comparative)

This comparison shows that the sulfonated polymers (i.e., A, B, C and E) are poor calcium carbonate scale inhibitors, producing worse results than having no polymer present.

### Example 12

### Comparison Showing Copolymer Performance Versus Mw

Example 12 compared the anti-scaling effect of copolymers having different molecular weights but the same compositions (70% AA and 30% NaAMPS), in Base #5 (high silicate), to determine the performance drop off point and optimal Mw. The comparison took place over two runs, A and B.

### Example 12A

Example 12A was carried out at water hardness of 375 ppm (2:1 Ca²⁺:Mg²⁺)

For each cycle run, 40 g of the specified base formulation and 1.875% (0.75 g) polymer solids were added to each of the pre-wash and the main wash.

TABLE 12A

| | | Polymer |
|---|---|---|
| | Filming Rating | Molecular |
| Description | after 4 Cycles | Weight |
| 1) Base #5 without polymer | 3.4 | N/A |
| 2) Base #5 + 0.75 g Polymer A | 3.27 | 20,940 |
| 3) Base #5 + 0.75 g Polymer M | 2.4 | 51,262 |
| 4) Base #5 + 0.75 g Polymer N | 2.33 | 72,020 |
| 5) Base #5 + 0.75 g Polymer O | 2.2 | 100,960 |
| 6) Base #5 + 0.75 g Polymer P | 2 | 126,220 |

Polymers A (Comparative), M, N, O and P were all copolymers of 70% AA and 30% NaAMPS

### Example 12B

Example 12B was carried out at water hardness of 400 ppm (2:1 Ca²⁺:Mg²⁺).

For each cycle run, 40 g of the specified base formulation and 1.5% (0.60 g) polymer solids were added to each of the pre-wash and the main wash.

TABLE 12B

| | | Polymer |
|---|---|---|
| | Filming Rating | Molecular |
| Description | after 8 Cycles | Weight |
| 1) Base #5 without polymer | 4.60 | N/A |
| 2) Base #5 + 0.60 g Polymer A | 3.97 | 20,940 |
| 3) Base #5 + 0.60 g Polymer O | 3.27 | 100,960 |
| 4) Base #5 + 0.60 g Polymer P | 2.03 | 126,220 |
| 5) Base #5 + 0.60 g Polymer Q | 2.73 | 155,150 |
| 6) Base #5 + 0.60 g Polymer R | 3.10 | 191,080 |

Polymers A (Comparative), O, P, Q and R were all copolymers of 70% AA and 30% NaAMPS

### Example 13

### Comparison Showing Terpolymer Performance Versus Mw

Example 13 compared the anti-scaling effect of terpolymers having different molecular weights but the same compositions (70% AA, 15% NaAMPS, and 15% EA), in Base #7 ((phosphonate-containing), to determine the performance drop off point and optimal Mw.

For each cycle run, 50 g of the specified base formulation and 0.3% (0.15 g) polymer solids were added to each of the pre-wash and the main wash.

TABLE 13

| | | Polymer |
|---|---|---|
| | Filming Rating | Molecular |
| Description | after 9 Cycles | Weight |
| 1) Base #7 + 0.15 g Polymer B | 3.35 | 35,903 |
| 2) Base #7 + 0.15 g Polymer S | 3.05 | 79,052 |
| 3) Base #7 + 0.15 g Polymer T | 3.05 | 102,970 |
| 4) Base #7 + 0.15 g Polymer U | 2.70 | 124,920 |
| 5) Base #7 + 0.15 g Polymer V | 2.70 | 149,910 |
| 6) Base #7 + 0.15 g Polymer W | 2.95 | 205,850 |

Polymers B, S, T, U, V and W were all terpolymers of 70% AA, 15% NaAMPS, and 15% EA.

We claim:

1. Method of controlling scale in aqueous dishwashing systems comprising: adding to the aqueous system at least one terpolymer comprising polymerized units of the following monomers:
(I) 50-88% by weight of one or more weak acids selected from the group consisting of monoethylenically unsaturated C₃ to C₆ monocarboxylic acids, and water soluble salts thereof;
(II) 10-48% by weight of one or more unsaturated sulfonic acids of the formula:
R⁵(R⁶)C═C(R⁷)—X—SO₃Z
wherein Z may be one or more of hydrogen, sodium, potassium, ammonium, a divalent cation or combinations thereof; R⁵ to R⁷, independently of one another, represent —H, —CH₃, a linear or branched, saturated alkyl group containing 2 to 12 carbon atoms, a linear or branched, mono- or polyunsaturated alkenyl group containing 2 to 12 carbon atoms, —NH₂—, —OH— or —COOH-substituted alkyl or alkenyl groups, as defined above, or —COOH or —COOR⁴, where R⁴ is a saturated or unsaturated, linear or branched hydrocarbon radical containing 1 to 12 carbon atoms, and X is an optionally present spacer group selected from —(CH₂)ₙ— with n=0 to 4, —COO—(CH₂)ₖ— with k=1 to 6, —C(O)NH—C(CH₃)₂—, —C(O)NH—CH(CH₂CH₃)—, —C(O)NH—C(CH₃)₂CH₂, —C(O)NH—CH₂CH(OH)CH₂, —CH₂—O—C₆H₄, —C₆H₄, —CH₂OCH₂CH(OH)CH₂, —C(O)NH—CH₂CH₂CH₂, —C(O)NH and —C(O)NH—CH₂, or water soluble salts thereof, or is of the formula
HO₃S—X—(R⁸)C═C(R⁹)—X—SO₃Z
in which R⁸ and R⁹, independently of one another, are selected from —H, —CH₃, —CH₂CH₃, —CH₂CH₂CH₃, —CH(CH₃)₂, and X and Z are as hereinbefore defined, or water soluble salts thereof;
(III) 2-35% by weight of one or more monoethylenically unsaturated monomers polymerizable with (I) and (II);
wherein the total of monomers (I), (II) and (III) equals 100% by weight of terpolymer; and further wherein the scale being controlled is selected from the group consisting of: silica, calcium silicate, magnesium silicate, zinc silicate, iron silicate, and the calcium, magnesium, zinc, and iron salts of phosphonates, aminocarboxylates, and hydroxycarboxylates, and combinations thereof; and further wherein the weight average molecular weight of the terpolymer is from 20,000 to 225,000.

2. Method according to claim 1, wherein the monoethylenically unsaturated C₃ to C₆ monocarboxylic acid is selected from the group consisting of one or more of acrylic acid and methacrylic acid, and wherein the one or more unsaturated sulfonic acids is selected from the group consisting of 2-acrylamido-2-methyl-1-propanesulfonic acid, 2-methacrylamido-2-methyl-1-propanesulfonic acid, and water soluble salts thereof.

3. Method according to claim 1, wherein the weight average molecular weight of the terpolymer is from 20,000 to 150,000.

4. Method according to claim 1, wherein the terpolymer is added to a machine dishwashing formulation having not more than 2% by weight of one or more phosphate groups, based on the total weight of the formulation and used in the aqueous system and the aqueous system is a wash bath of a dishwashing machine.

5. Method of controlling scale in aqueous dishwashing systems comprising adding to the aqueous system at least one copolymer comprising polymerized units of the following monomers:
(I) 50-98% by weight of one or more weak acids selected from the group consisting of monoethylenically unsaturated C₃ to C₆ monocarboxylic acids, and water soluble salts thereof; and
(II) 2-50% by weight of one or more unsaturated sulfonic acids of the formula:
R⁵(R⁶)C═C(R⁷)—X—SO₃Z
wherein Z may be one or more of hydrogen, sodium, potassium, ammonium, a divalent cation or combinations thereof; R⁵ to R⁷, independently of one another, represent —H, —CH₃, a linear or branched, saturated alkyl group containing 2 to 12 carbon atoms, a linear or branched, mono- or polyunsaturated alkenyl group containing 2 to 12 carbon atoms, —NH₂—, —OH— or —COOH-substituted alkyl or alkenyl groups, as defined above, or —COOH or —COOR⁴, where R⁴ is a saturated or unsaturated, linear or branched hydrocarbon radical containing 1 to 12 carbon atoms, and X is an optionally present spacer group selected from —(CH₂)ₙ— with n=0 to 4, —COO—(CH₂)ₖ— with k=1 to 6, —C(O)NH—C(CH₃)₂—, —C(O)NH—CH(CH₂CH₃)—, —C(O)NH—C(CH₃)₂CH₂, —C(O)NH—CH₂CH(OH)CH₂, —CH₂—O—C₆H₄, —C₆H₄, —CH₂OCH₂CH(OH)CH₂, —C(O)NH—CH₂CH₂CH₂, —C(O)NH and —C(O)NH—CH₂, or water soluble salts thereof, or is of the formula
HO₃S—X—(R⁸)C═C(R⁹)—X—SO₃Z
in which R⁸ and R⁹, independently of one another, are selected from —H, —CH₃, —CH₂CH₃, —CH₂CH₂CH₃, —CH(CH₃)₂, and X and Z are as hereinbefore defined, or water soluble salts thereof;
wherein the total of monomers (I) and (II) equals 100% by weight of copolymer; wherein the scale being controlled is selected from the group consisting of: silica, calcium silicate, magnesium silicate, zinc silicate, iron silicate, and the calcium, magnesium, zinc, and iron salts of phosphonates, aminocarboxylates, and hydroxycarboxylates, and combinations thereof; and further wherein the weight average molecular weight of the copolymer is from 30,000 to 225,000.

6. Method according to claim 5, wherein the monoethylenically unsaturated C₃ to C₆ monocarboxylic acid is selected from the group consisting of one or more of acrylic acid and methacrylic acid, and wherein the one or more unsaturated sulfonic acids is selected from the group consisting of 2-acrylamido-2-methyl-1-propanesulfonic acid, 2-methacrylamido-2-methyl-1-propanesulfonic acid, and water soluble salts thereof.

7. Method according to claim 5, wherein the weight average molecular weight of the copolymer is from 30,000 to 150,000.

8. Method according to claim 5, wherein the copolymer is added to a machine dishwashing formulation having not more than 2% by weight of one or more phosphate groups, based on the total weight of the formulation and used in the aqueous system and the aqueous system is a wash bath of a dishwashing machine.

9. A machine dishwashing formulation comprising:
a) 1 to 99.9% by weight of at least one builder, which comprises not more than 2% by weight of one or more phosphate builders, based on the total weight of the dishwashing formulation; and
b) 0.1 to 70% by weight of:
(b1) at least one terpolymer comprising polymerized units of the following monomers:
I) 50-88% by weight of one or more weak acids selected from the group consisting of monoethylenically unsaturated C₃ to C₆ monocarboxylic acids, and water soluble salts thereof;
II) 10-48% by weight of one or more unsaturated sulfonic acids of the formula:
R⁵(R⁶)C═C(R⁷)—X—SO₃Z
wherein Z may be one or more of hydrogen, sodium, potassium, ammonium, a divalent cation or combinations thereof; R⁵ to R⁷, independently of one another, represent —H, —CH₃, a linear or branched, saturated alkyl group containing 2 to 12 carbon atoms, a linear or branched, mono- or polyunsaturated alkenyl group containing 2 to 12 carbon atoms, —NH₂—, —OH— or —COOH-substituted alkyl or alkenyl groups, as defined above, or —COOH or —COOR⁴, where R⁴ is a saturated or unsaturated, linear or branched hydrocarbon radical containing 1 to 12 carbon atoms, and X is an optionally present spacer group selected from —(CH₂)ₙ— with n=0 to 4, —COO—(CH₂)ₖ— with k=1 to 6, —C(O)NH—C(CH₃)₂—, —C(O)NH—CH(CH₂CH₃)—, —C(O)NH—C(CH₃)₂CH₂, —C(O)NH—CH₂CH(OH)CH₂, —CH₂—O—C₆H₄, —C₆H₄, —CH₂OCH₂CH(OH)CH₂, —C(O)NH—CH₂CH₂CH₂, —C(O)NH and —C(O)NH—CH₂, or water soluble salts thereof, or is of the formula
HO₃S—X—(R⁸)C═C(R⁹)—X—SO₃Z
in which R⁸ and R⁹, independently of one another, are selected from —H, —CH₃, —CH₂CH₃, —CH₂CH₂CH₃, —CH(CH₃)₂, and X and Z are as hereinbefore defined, or water soluble salts thereof; and
III) 2-35% by weight of one or more monoethylenically unsaturated monomers polymerizable with (I) and (II);
wherein the total of monomers (I), (II) and (III) equals 100% by weight of the terpolymer, and further wherein the weight average molecular weight of the terpolymer is from 20,000 to 225,000; or
(b2) at least one copolymer comprising polymerized units of the following monomers:
(I) 50-98% by weight of one or more weak acids selected from the group consisting of monoethylenically unsaturated C₃ to C₆ monocarboxylic acids, and water soluble salts thereof; and
(II) 2-50% by weight of one or more unsaturated sulfonic acids of the formula:
R⁵(R⁶)C═C(R⁷)—X—SO₃Z
wherein Z may be one or more of hydrogen, sodium, potassium, ammonium, a divalent cation or combinations thereof; R⁵ to R⁷, independently of one another, represent —H, —CH₃, a linear or branched, saturated alkyl group containing 2 to 12 carbon atoms, a linear or branched, mono- or polyunsaturated alkenyl group containing 2 to 12 carbon atoms, —NH₂—, —OH— or —COOH-substituted alkyl or alkenyl groups, as defined above, or —COOH or —COOR⁴, where R⁴ is a saturated or unsaturated, linear or branched hydrocarbon radical containing 1 to 12 carbon atoms, and X is an optionally present spacer group selected from —(CH₂)ₙ— with n=0 to 4, —COO—(CH₂)ₖ— with k=1 to 6, —C(O)NH—C(CH₃)₂—, —C(O)NH—CH(CH₂CH₃)—, —C(O)NH—C(CH₃)₂CH₂, —C(O)NH—CH₂CH(OH)CH₂, —CH₂—O—C₆H₄, —C₆H₄, —CH₂OCH₂CH(OH)CH₂, —C(O)NH—CH₂CH₂CH₂, —C(O)NH and —C(O)NH—CH₂, or water soluble salts thereof, or is of the fonmula
HO₃S—X—(R⁸)C═C(R⁹)—X—SO₃Z
in which R⁸ and R⁹, independently of one another, are selected from —H, —CH₃, —CH₂CH₃, —CH₂CH₂CH₃, —CH(CH₃)₂, and X and Z are as hereinbefore defined, or water soluble salts thereof;
wherein the total of monomers (I) and (II) equals 100% by weight of copolymer, and further wherein the weight average molecular weight of the copolymer is from 30,000 to 225,000; or
(b3) a combination of (b1) and (b2).

10. The machine dishwashing fonnulation according to claim 9, wherein the monoethylenically unsaturated C₃ to C₆ monocarboxylic acid is selected from the group consisting of one or more of acrylic acid and methacrylic acid, and wherein the one or more unsaturated sulfonic acids is selected from the group consisting of 2-acrylamido-2-methyl-1-propanesulfonic acid, 2-methacrylamido-2-methyl-1-propanesulfonic acid, and water soluble salts thereof.

11. A machine dishwasher rinse aid formulation comprising:
(b1) at least one terpolymer comprising polymerized units of the following monomers:
I) 50-88% by weight of one or more weak acids selected from the group consisting of monoethylenically unsaturated C₃ to C₆ monocarboxylic acids, and water soluble salts thereof;
II) 10-48% by weight of one or more unsaturated sulfonic acids of the formula:
R⁵(R⁶)C═C(R⁷)—X—SO₃Z
wherein Z may be one or more of hydrogen, sodium, potassium, ammonium, a divalent cation or combinations thereof; R⁵ to R⁷, independently of one another, represent —H, —CH₃, a linear or branched, saturated alkyl group containing 2 to 12 carbon atoms, a linear or branched, mono- or polyunsaturated alkenyl group containing 2 to 12 carbon atoms, —NH₂—, —OH— or —COOH-substituted alkyl or alkenyl groups, as defined above, or —COOH or —COOR⁴, where R⁴ is a saturated or unsaturated, linear or branched hydrocarbon radical containing 1 to 12 carbon atoms, and X is an optionally present spacer group selected from —(CH₂)ₙ— with n=0 to 4, —COO—(CH₂)ₖ— with k=1 to 6, —C(O)NH—C(CH₃)₂—, —C(O)NH—CH(CH₂CH₃)—, —C(O)NH—C(CH₃)₂CH₂, —C(O)NH—CH₂CH(OH)CH₂, —CH₂—O—C₆H₄, —C₆H₄, —CH₂OCH₂CH(OH)CH₂, —C(O)NH—CH₂CH₂CH₂, —C(O)NH and —C(O)NH—CH₂, or water soluble salts thereof, or is of the formula
HO₃S—X—(R⁸)C═C(R⁹)—X—SO₃Z
in which R⁸ and R⁹, independently of one another, are selected from —H, —CH₃, —CH₂CH₃, —CH₂CH₂CH₃, —CH(CH₃)₂, and X and Z are as hereinbefore defined, or water soluble salts thereof, and
III) 2-35% by weight of one or more monoethylenically unsaturated monomers polymerizable with (I) and (II);
wherein the total of monomers (I), (II) and (III) equals 100% by weight of the terpolymer, and further wherein the weight average molecular weight of the terpolymer is from 20,000 to 225,000; or
(b2) at least one copolymer comprising polymerized units of the following monomers:
(I) 50-98% by weight of one or more weak acids selected from the group consisting of monoethylenically unsaturated C₃ to C₆ monocarboxylic acids, and water soluble salts thereof; and
(II) 2-50% by weight of one or more unsaturated sulfonic acids of the formula:
R⁵(R⁶)C═C(R⁷)—X—SO₃Z
wherein Z may be one or more of hydrogen, sodium, potassium, ammonium, a divalent cation or combinations thereof; R⁵ to R⁷, independently of one another, represent —H, —CH₃, a linear or branched, saturated alkyl group containing 2 to 12 carbon atoms, a linear or branched, mono- or polyunsaturated alkenyl group containing 2 to 12 carbon atoms, —NH₂—, —OH— or —COOH-substituted alkyl or alkenyl groups, as defined above, or —COOH or —COOR⁴, where R⁴ is a saturated or unsaturated, linear or branched hydrocarbon radical containing 1 to 12 carbon atoms, and X is an optionally present spacer group selected from —(CH₂)ₙ— with n=0 to 4, —COO—(CH₂)ₖ— with k=1 to 6, —C(O)NH—C(CH₃)₂—, —C(O)NH—CH(CH₂CH₃)—, —C(O)NH—C(CH₃)₂CH₂, —C(O)NH—CH₂CH(OH)CH₂, —CH₂—O—C₆H₄, —C₆H₄, —CH₂OCH₂CH(OH)CH₂, —C(O)NH—CH₂CH₂CH₂, —C(O)NH and —C(O)NH—CH₂, or water soluble salts thereof, or is of the formula
HO₃S—X—(R⁸)C═C(R⁹)—X—SO₃Z
in which R⁸ and R⁹, independently of one another, are selected from —H, —CH₃, —CH₂CH₃, —CH₂CH₂CH₃, —CH(CH₃)₂, and X and Z are as hereinbefore defined, or water soluble salts thereof;
wherein the total of monomers (I) and (II) equals 100% by weight of copolymer, and further wherein the weight average molecular weight of the copolymer is from 30,000 to 225,000; or
(b3) a combination of (b1) and (b2).
